(19) United States
(12) Patent Application Publication
(10) Pub. No.: US 2018/0065198 A1
(43) Pub. Date: Mar. 8, 2018

(54) MULTIPLE BLADE TABLE SAW WITH ADJUSTABLE ROUTER ATTACHMENT

(71) Applicant: James Glen Holder, BRIDGEPORT, TX (US)

(72) Inventor: James Glen Holder, BRIDGEPORT, TX (US)

(21) Appl. No.: 15/260,111

(22) Filed: Sep. 8, 2016

(51) Int. Cl. B23D 45/10; B27B 5/16; B27B 5/26; B27C 5/02; B23D 45/06

(52) U.S. Cl. CPC B23D 45/10; B27B 5/165; B23D 45/068; B27C 5/02; B27B 5/265

(57) ABSTRACT

A multiple blade table saw for use with a tool attachment assembly enables a user to perform different woodworking tasks simultaneously on plywood to enhance efficiency. The table saw assembly includes a housing to store a blade assembly having a plurality of blades operably connected to a motor, a tabletop coupled to a top of the housing and having a first slot and a second slot, the first slot able to permit portions of the plurality of blades to extend therethrough to be exposed above the tabletop, and a carriage slidably mounted to the housing and able to secure the tool attachment assembly. The tool attachment assembly includes a cutting member that is positioned within the second slot of the tabletop. The user maneuvers a plywood sheet on the tabletop to permit the blade assembly and cutting member to cut the plywood sheet.

### BACKGROUND

The embodiments herein relate generally to table saws and other equipment used in woodworking applications such as the construction of cabinet drawers.

Table saws and other equipment such as routers used in woodworking are useful for cutting and/or shaping plywood to help a user to build finished products such as drawers, tables, shelves, other structures, or the like. Individuals may cut the plywood to a desired size, create a groove within the plywood and/or shape the plywood by creating a bullnose on an edge.

Several saw devices for use in woodworking are disclosed in U.S. Pat. Nos. 8,539,870, 8,746,668 and 4,445,412. These devices comprise at least one blade that is designed to cut a piece of plywood. However, these devices are limited because they do not permit a user to perform different woodworking tasks simultaneously such as cutting the plywood, creating a groove in the plywood and carving an edge to create a bullnose. Current woodworking devices and methods require a user to perform these different tasks separately with multiple pieces of equipment. This is inefficient and creates significant burdens on the user.

As such, there is a need in the industry for a multiple blade table saw with an adjustable router attachment that addresses the limitations of the prior art, which permits a user to perform different woodworking tasks at one time to improve efficiency in completing a project.

### SUMMARY

A multiple blade table saw for use with an adjustable tool attachment assembly is provided. The multiple blade table saw is configured to enable a user to perform different woodworking tasks simultaneously on plywood to enhance efficiency. The multiple blade table saw assembly comprises a housing configured to store a blade assembly comprising a plurality of blades operably connected to a motor, a tabletop coupled to a top of the housing and comprising a first slot and a second slot, the first slot configured to permit portions of the plurality of blades to extend therethrough to be exposed above the tabletop, and a carriage slidably mounted to the housing and configured to secure the tool attachment assembly thereto, the tool attachment assembly comprising a cutting member that is positioned within the second slot of the tabletop, wherein the carriage is slidably adjusted to place the cutting member at a desired location, wherein a user maneuvers a plywood sheet on the tabletop to permit the blade assembly and cutting member to cut the plywood sheet.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the multiple blade table saw shown in use;

FIG. 2 depicts a perspective view of certain embodiments of the multiple blade table saw shown in use;

FIG. 3 depicts a perspective view of certain embodiments of the multiple blade table saw without table plate 44 for illustrative clarity;

FIG. 4 depicts an exploded view of certain embodiments of the multiple blade table saw;

FIG. 5 depicts a section view of certain embodiments of the multiple blade table saw taken along line 5-5 in FIG. 2; and

FIG. 6 depicts a perspective view of an exemplary wood piece 36 used with certain embodiments of the multiple blade table saw.

### DETAILED DESCRIPTION OF CERTAIN EMBODIMENTS

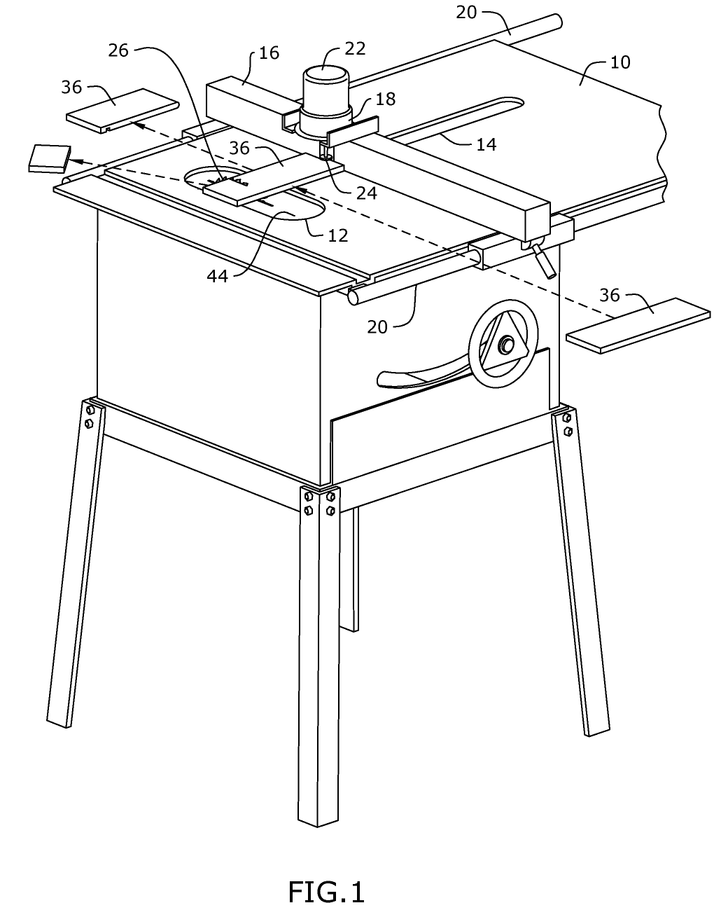

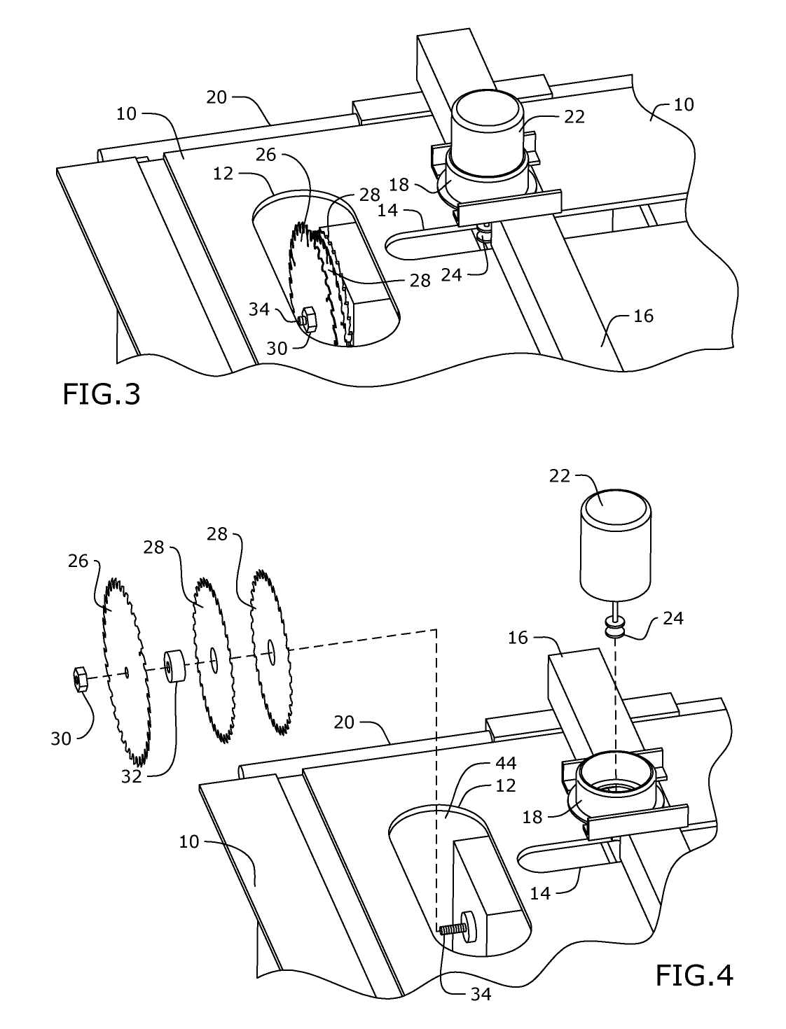

As depicted in FIGS. 1-3, the multiple blade table saw is configured to perform different woodworking tasks on wood piece 36. Wood piece 36 may be any type of wood member such as plywood having variable sizes. Although the figures depict wood piece 36 having a certain size in relation to the table saw, it shall be appreciated that the table saw may be used with larger plywood sheets with dimensions such as 4′×8′×½″.

The multiple blade table saw comprises a housing with a plurality of supporting legs, tabletop 10, table plate 44, circular blade 26, a pair of dado blades 28, router 22 and router bullnose bit 24. Table plate 44 is disposed on top of the housing and tabletop 10 is placed on top of table plate 44. Tabletop 10 serves as a generally flat work surface and comprises blade slot 12 and router slot 14.

Router 22 comprises any type of router known in the field and is slidably mounted to the housing by router carriage 16, router bracket 18 and carriage rails 20. Specifically, router carriage 16 is slidably mounted to carriage rails 20, which are affixed to opposing sides of the housing. Router bracket 18 is coupled to an intermediate portion of router carriage 16 proximate router slot 14. Router 22 is disposed within an opening in router bracket 18 and is configured to receive a bit such as bullnose bit 24. Once the components are secured together, bullnose bit 24 is positioned within router slot 14. In this configuration, a user can slidably adjust router carriage 16 along carriage rails 20 to position bullnose bit 24 in a desired position anywhere within router slot 14. In one embodiment, a locking handle-type mechanism is used to secure router carriage 16 to carriage rails 20 in a stationary position once the desired position is achieved.

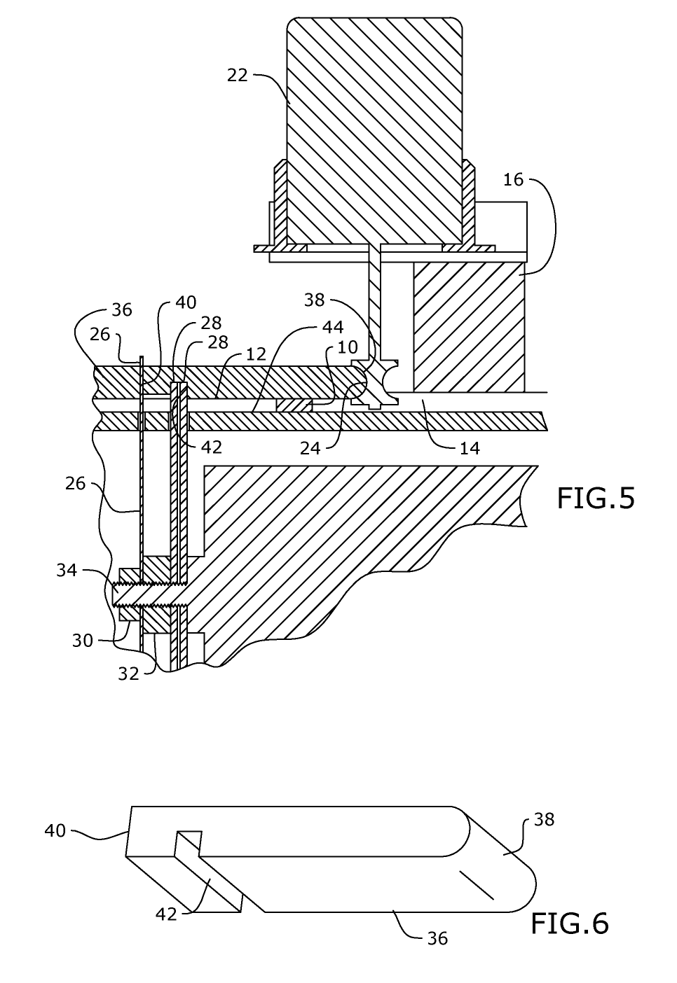

Circular blade 26, and dado blades 28 are operably connected to a motor (not shown) within the housing. Circular blade 26 is preferably a 10″ saw blade and each dado blade 28 is preferably an 8″ saw blade. However, alternative sized blades may be used instead. As depicted in FIG. 4, a motor (not shown) stored within the housing comprises rotatable threaded shaft 34, which is configured to receive dado blades 28 and circular blade 26. Specifically, dado blades 28 are disposed around threaded shaft 34, spacer 32 is disposed around threaded shaft 34 and placed against one dado blade 28 of the pair, circular blade 26 is disposed around threaded shaft 34 and placed against spacer 32, and nut 30 is coupled to threaded shaft 34 and placed against circular blade 26. Spacer 32 is preferably an aluminum tubular member with a thickness of ½″ and diameter of 2″. However, alternative sized spacers may be used instead. As depicted in FIG. 5, nut 30 is tightened to secure circular blade 26 and dado blades 28 together. In the secured position, the top portions of circular blade 26 and dado blades 28 extend through table plate 44 and blade slot 12 such that the tips of blades 26, 28 are exposed above tabletop 10. These exposed portions of blades 26, 28 cut wood piece 36 when placed on tabletop 10.

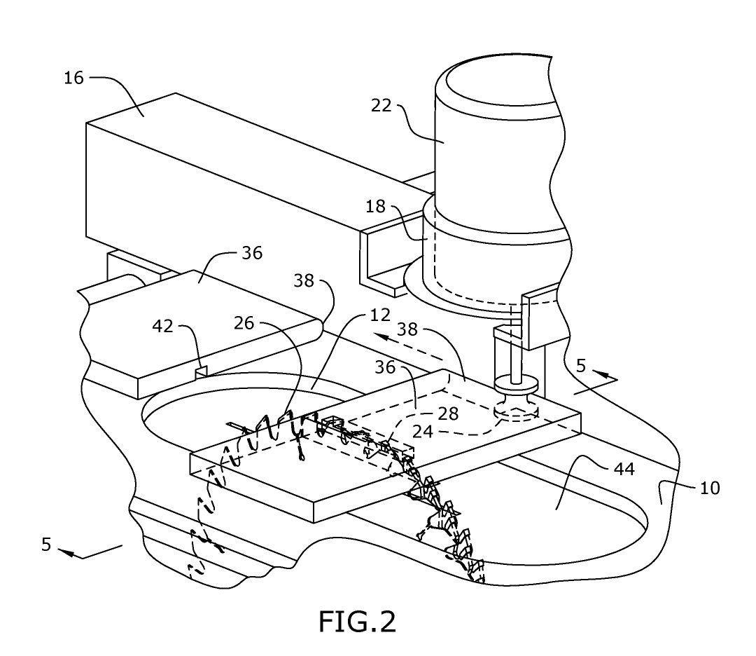

To operate the multiple blade table saw, a user slidably adjusts router carriage 16 to a desired position. Router carriage 16 is locked into place. In a preferred embodiment, router carriage 16 may be adjusted such that the distance between circular blade 26 and the side edge of router carriage 16 is anywhere between 3½″ to 15″. However, an alternative distance range may be permitted for adjustments. The motor is enabled to permit blades 26, 28 to rotate. Router 22 is enabled to permit router bullnose bit 24 to rotate. As depicted in FIGS. 1-2, a user (not shown) places wood piece 36 on tabletop 10 and against a side edge of router carriage 16. In a smooth motion, wood piece 36 is pushed through blades 26, 28 and router bullnose bit 24 along a path depicted by the arrows in FIGS. 1-2. During this process, circular blade 26 extends entirely through the thickness of wood piece 36 and cuts the wood into two pieces. Dado blades 28 extend into a portion of the wood to create groove 42 in wood piece 36. Router bullnose bit 24 contacts an edge of wood piece 36 to create bullnose 38. FIG. 6 depicts a finished wood piece 36 after being passed through the multiple blade table saw. Finished wood piece 36 comprises bullnose 38, groove 42 and cut surface 40. In one embodiment, groove 42 comprises a cross sectional cutout with dimensions of approximately ¼″×½″. However, the size of groove 42 may vary depending on the size and positioning of dado blades 28. It shall be apparent that the multiple blade table saw is advantageous because it permits a user to simultaneously cut wood piece 36, create slot 42 and bullnose 38, in one fluid motion. This greatly enhances user efficiency in completing different woodworking tasks.

It shall be appreciated that the components of the multiple blade table saw described in several embodiments herein may comprise any alternative known materials in the field and be of any color, size and/or dimensions. Although the figures depict a router attached to the carriage, it shall be appreciated that alternative tools known in the field may be secured thereto instead. It shall be appreciated that the components of the multiple blade table saw described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

1. A multiple blade table saw for use with an adjustable tool attachment assembly, the multiple blade table saw configured to enable a user to perform different woodworking tasks simultaneously on plywood to enhance efficiency, the multiple blade table saw assembly comprising:
a housing configured to store a blade assembly comprising a plurality of blades operably connected to a motor, the plurality of blades comprising a first blade and a pair of dado blades directly adjacent to each other with no intermediary spacer between the pair of dado blades, the pair of dado blades separated a distance from the first blade, the first blade comprising a first diameter that is greater than a second diameter of each dado blade in the pair of dado blades;
a tabletop coupled to a top of the housing and comprising a first slot and a second slot, the first slot configured to permit portions of the first blade and pair of dado blades to extend therethrough above the tabletop; and
a carriage slidably mounted to the housing and configured to secure a tool attachment assembly thereto, the tool attachment assembly comprising a cutting member that is positioned within the second slot of the tabletop, wherein the carriage is slidably adjusted to place the cutting member at a desired location, wherein a user maneuvers a plywood sheet on the tabletop to permit the blade assembly and cutting member to cut the plywood sheet, wherein the first diameter of the first blade permits the first blade to cut entirely through the plywood sheet, wherein the second diameter of the pair of dado blades permits the dado blades to partially extend into the plywood sheet, thereby creating a single groove in the plywood sheet.

2. (canceled)

3. The multiple blade table saw of claim 1, wherein the motor comprises a rotatable threaded shaft, the pair of dado blades is disposed around the threaded shaft, a spacer is disposed around the threaded shaft and positioned against the pair of dado blades, the first blade is disposed around the threaded shaft and positioned against the spacer, and a nut is coupled to the threaded shaft and positioned against the first blade.

4. The multiple blade table saw of claim 3, wherein the tool attachment assembly comprises a router and the cutting member comprises a bullnose bit.

5. The multiple blade table saw of claim 4, further comprising a bracket coupled to the carriage, wherein the bracket is configured to receive the router.

6. A multiple blade table saw for use with an adjustable tool attachment assembly, the multiple blade table saw configured to enable a user to perform different woodworking tasks simultaneously on plywood to enhance efficiency, the multiple blade table saw assembly comprising:
a housing configured to store a blade assembly comprising a plurality of blades operably connected to a motor, the plurality of blades comprising a first blade and a pair of dado blades directly adjacent and attached to each other with no intermediary spacer between the pair of dado blades, the pair of dado blades separated a distance from the first blade, the first blade comprising a first diameter that is greater than a second diameter of each dado blade in the pair of dado blades;
a tabletop coupled to a top of the housing and comprising a first slot and a second slot, the first slot configured to permit portions of the first blade and pair of dado blades to extend therethrough above the tabletop; and
a carriage slidably mounted to the housing and configured to secure a tool attachment assembly thereto, the tool attachment assembly comprising a cutting member that is positioned within the second slot of the tabletop, wherein the carriage is slidably adjusted to place the cutting member at a desired location;
wherein a user maneuvers a plywood sheet on the tabletop to permit the blade assembly and cutting member to simultaneously cut the plywood sheet, wherein the first diameter of the first blade permits the first blade to cut entirely through the plywood sheet, wherein the second diameter of the pair of dado blades permits the dado blades to partially extend into the plywood sheet, thereby creating a single groove in the plywood sheet, wherein the cutting member creates a bullnose on an edge of the plywood sheet.
